(19) United States
(12) Patent Application Publication
(10) Pub. No.: US 2023/0182773 A1
(43) Pub. Date: Jun. 15, 2023

(54) METHOD AND APPARATUS USED FOR PROVIDING A TRAVEL STRATEGY FOR AN AUTOMATED VEHICLE FOR A PREDETERMINED RANGE

(71) Applicant: Robert Bosch GmbH, Stuttgart (DE)

(72) Inventor: Marlon Ramon Ewert, Untergruppenbach (DE)

(21) Appl. No.: 18/060,062

(22) Filed: Nov. 30, 2022

(30) Foreign Application Priority Data
Dec. 10, 2021 (DE) 10 2021 214 113.7

(51) Int. Cl. B60W 60/00; B60W 40/04

(52) U.S. Cl. CPC B60W 60/0011; B60W 40/04; B60W 2554/4041; B60W 2554/80; B60W 2555/60; B60W 2556/40; B60W 2556/65

(57) ABSTRACT

A method and apparatus for providing a travel strategy for an automated vehicle for a predetermined range. The method includes receiving movement data from further vehicles, wherein the movement data represent movement profiles of the further vehicles within the predetermined range; receiving map data values which represent a highly accurate map, wherein the highly accurate map comprises at least the predetermined range; creating the travel strategy for the automated vehicle within the predetermined range, based on the highly accurate map and depending on the movement profiles of the further vehicles, wherein the travel strategy comprises a trajectory for the automated vehicle; and providing the travel strategy for operating an automated vehicle.

### CROSS REFERENCE

The present application claims the benefit under 35 U.S.C. § 119 of German Patent Application No. DE 10 2021 214 113.7 filed on Dec. 10, 2021, which is expressly incorporated herein by reference in its entirety.

### FIELD

The present invention relates, among other things, to a method used for providing a travel strategy for an automated vehicle for a predetermined range, wherein the creation of the travel strategy for the automated vehicle is performed within the predetermined range, based on a highly accurate map and depending on movement profiles of other vehicles. The travel strategy in this case comprises a trajectory for the automated vehicle.

### SUMMARY

According to an example embodiment of the present invention, a method according to the present invention used for providing a travel strategy for an automated vehicle for a predetermined range comprises a step for receiving movement data from further vehicles, wherein the movement data represent movement profiles of the further vehicles within the predetermined range, and a step for receiving map data values which represent a highly accurate map, the highly accurate map comprising at least the predetermined range. The method further includes a step for creating the travel strategy for the automated vehicle within the predetermined range, based on the highly accurate map and depending on the movement profiles of the further vehicles, wherein the travel strategy comprises a trajectory for the automated vehicle, as well as a step for providing the travel strategy for operating an automated vehicle.

An automated vehicle is understood to mean a partially automated, highly automated, or fully automated vehicle in accordance with one of SAE levels 1 to 5 (see the SAE J3016 standard).

Operating an automated vehicle, in particular depending on the travel strategy, is understood to mean, e.g., performing lateral and/or longitudinal control of the automated vehicle, wherein the lateral and/or longitudinal control occurs in such a way that the automated vehicle moves along the trajectory. In one possible embodiment, the operation also comprises, e.g., performing safety-relevant functions (“arming” an airbag, locking the seatbelts, etc.) and/or further (driving assistance) functions.

A movement profile of the further vehicles within the predetermined range is understood to mean, e.g., trajectories of these further vehicles, i.e., the position profile of these further vehicles over time. The movement profile thus comprises, e.g., which vehicle, at what time and which position, was within the predetermined range and/or speed profiles of the further vehicles, and/or when which vehicle halted where, etc.

A trajectory is understood to mean—e.g., in relation to a map—a line that the automated vehicle follows. In one embodiment this line refers to, e.g., a fixed point on the automated vehicle. In a further possible embodiment, a trajectory is understood to mean, e.g., a travel envelope through which the automated vehicle travels.

In one possible embodiment of the present invention, the travel strategy additionally comprises a speed indication which the automated vehicle is intended to follow along the trajectory.

A highly accurate map is understood to mean a digital map in the form of (map) data values on a storage medium. For example, the highly accurate map is configured to encompass one or more map layers, wherein one map layer shows e.g. a map from bird's eye view (course and position of roads, buildings, landscape features, etc.). This corresponds to, e.g., a map of a navigation system. Another map layer includes, e.g., a radar map, wherein environmental features encompassed by the radar map are stored along with a radar signature. A further map layer comprises, e.g., a lidar map, wherein the environmental features encompassed by the lidar map are stored along with a lidar signature.

The highly accurate map is in particular configured to be suitable for the navigation of an automated vehicle. For example, this is understood to mean that the highly accurate map is configured to determine, by comparing stored environmental features with sensed sensor data values of the automated vehicle, a highly accurate position of this automated vehicle. To this end, the highly accurate map includes, e.g., these environmental features having highly accurate position information (coordinates).

A predetermined range is understood to mean, e.g., a specific section of road (for example, between two intersections and/or between two on or off ramps), and/or multiple interconnected traffic routes, etc.

The method according to the present invention may advantageously achieves an object of providing a method for operating an automated vehicle. This object may be achieved by means of the method according to the present invention in that a travel strategy for the automated vehicle is created, based on the movement data of further vehicles and by means of a highly accurate map. Based on the movement profiles, a corresponding algorithm is able to learn and improve a travel strategy, or the trajectory encompassed therein. Doing so enables the development of an intelligent algorithm for calculating a trajectory and the subsequent control of the vehicle actuators over time, wherein, e.g., only the highly accurate vehicle positions and speeds of the further vehicles, as well as the distances between these further vehicles, are needed to operate the automated vehicle accordingly. It is then possible to use the environmental sensing equipment already included in the automated vehicle only to detect pedestrians and other structures, and to dynamically avoid collisions with them. The number of environmental sensors in the vehicle can in this case be significantly reduced, which also makes the automated vehicle cheaper. In addition, fewer resources of the automated vehicle are thereby used to operate the automated vehicle, based on a highly accurate location and by means of a highly accurate map.

Preferably, the creation of the driving strategy additionally is performed as a function of the legal requirements applicable within the specified range.

Legal requirements are in particular understood to mean speed and/or distance requirements between vehicles, and/or requirements regarding the use of single or multiple lanes (travel directions for one-way roads, left or right traffic, turning regulations, etc.).

Preferably, the movement profiles of the further vehicles comprise distances between these further vehicles.

Preferably, creation of the travel strategy additionally is performed as a function of a configuration of traffic paths within the predetermined range.

A configuration of traffic paths is understood to mean, e.g., whether the traffic path comprises one or more lanes of travel per direction of travel and/or whether it is a highway, country road, field path, etc., and/or whether bridges, tunnels, intersections, etc. are included.

An apparatus according to an example embodiment of the present invention, in particular a computing unit, is configured to perform all of the method steps according to any of the methods disclosed herein used for providing a travel strategy for an automated vehicle for a predetermined range. A computing unit is understood to mean, e.g., a server or server network, or a cloud.

To this end, the apparatus comprises a computing unit in particular (processor, memory, storage medium), as well as suitable software for performing the method according to any of the methods disclosed herein. Furthermore, the apparatus comprises an interface for, by means of a communication apparatus, transmitting and receiving data values via a cable and/or wireless connection.

Also provided according to the present invention is a computer program comprising instructions which, when executed by a computer, prompt the computer program to perform a method according to any of the methods disclosed herein used for providing a travel strategy for an automated vehicle for a predetermined range. In one embodiment, the computer program corresponds to software comprised by the apparatus. The computer program is in particular understood to mean an intelligent algorithm which learns to determine a travel strategy for the automated vehicle based on the movement profiles, or based on the many traffic situations and the highly accurate vehicle positions in reference to a highly accurate map, as well as the position changes of the further vehicles relative to one another. In one embodiment, a computer program may include, e.g., a neural network or artificial intelligence used for determining a travel strategy or planning a trajectory of a vehicle and/or for operating an automated vehicle.

Also provided according to the present invention is a machine-readable storage medium, on which the computer program product is stored.

Advantageous embodiments of the present invention are disclosed herein.

### BRIEF DESCRIPTION OF THE DRAWING

Embodiment examples of the present invention are illustrated in the figure and explained in greater detail in the following description.

FIG. 1 shows an example embodiment of the method according to the present invention used for providing a travel strategy for an automated vehicle for a predetermined range in the form of a flow chart.

### DETAILED DESCRIPTION OF EXAMPLE EMBODIMENTS

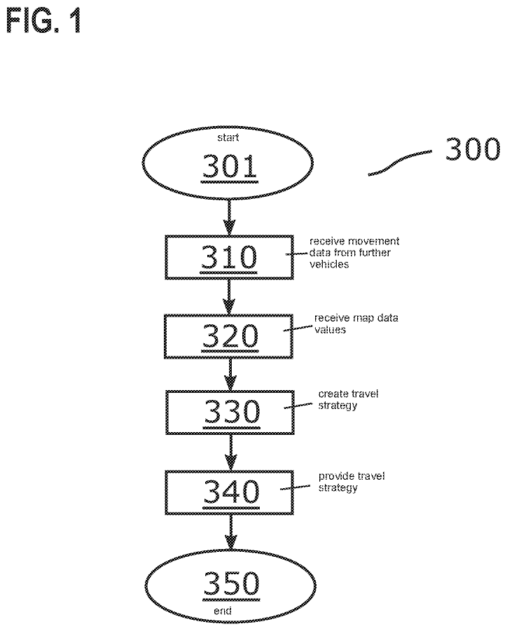

FIG. 1 illustrates one possible exemplary embodiment of a method 300 used for providing 340 a travel strategy for an automated vehicle for a predetermined range.

The method 300 starts at step 301.

In step 310, movement data are received from further vehicles, wherein the movement data represent movement profiles of the further vehicles within the predetermined range.

In step 320, map data values representing a highly accurate map are received, wherein the highly accurate map comprises at least the predetermined range.

In step 330, the travel strategy for the automated vehicle is created within the predetermined range, based on the highly accurate map and depending on the movement profiles of the further vehicles. The travel strategy in this case comprises a trajectory for the automated vehicle.

In step 340, the travel strategy for operating an automated vehicle is provided.

The method 300 ends at step 350.

What is claimed is:

1. A method for providing travel strategy for an automated vehicle for a predetermined range, the method comprising the following steps:
receiving movement data from further vehicles, wherein the movement data represent movement profiles of the further vehicles within the predetermined range;
receiving map data values representing a highly accurate map, wherein the highly accurate map includes at least the predetermined range;
creating the travel strategy for the automated vehicle within the predetermined range, based on the highly accurate map and depending on the movement profiles of the further vehicles, wherein the travel strategy includes a trajectory for the automated vehicle; and
providing the travel strategy for operating an automated vehicle.

2. The method according to claim 1, wherein the creation of the travel strategy additionally takes place as a function of legal requirements applicable within the specified range.

3. The method according to claim 1, wherein the movement profiles of the further vehicles include distances between these further vehicles.

4. The method according to claim 1, wherein the creation of the travel strategy additionally takes place as a function of a configuration of traffic paths within the predetermined range.

5. An apparatus configured to provide travel strategy for an automated vehicle for a predetermined range, the apparatus configured to:
receive movement data from further vehicles, wherein the movement data represent movement profiles of the further vehicles within the predetermined range;
receive map data values representing a highly accurate map, wherein the highly accurate map includes at least the predetermined range;
create the travel strategy for the automated vehicle within the predetermined range, based on the highly accurate map and depending on the movement profiles of the further vehicles, wherein the travel strategy includes a trajectory for the automated vehicle; and
provide the travel strategy for operating an automated vehicle.

6. A non-transitory machine-readable storage medium on which is stored a computer program for providing travel strategy for an automated vehicle for a predetermined range, the computer program, when executed by a computer, causing the computer to perform the following steps:
receiving movement data from further vehicles, wherein the movement data represent movement profiles of the further vehicles within the predetermined range;
receiving map data values representing a highly accurate map, wherein the highly accurate map includes at least the predetermined range;
creating the travel strategy for the automated vehicle within the predetermined range, based on the highly accurate map and depending on the movement profiles of the further vehicles, wherein the travel strategy includes a trajectory for the automated vehicle; and
providing the travel strategy for operating an automated vehicle.
